(19) United States
(12) Patent Application Publication
(10) Pub. No.: US 2023/0248151 A1
(43) Pub. Date: Aug. 10, 2023

(54) LUMBAR SUPPORT

(71) Applicant: GRBIC, Svetozar, Munchen (IL)

(72) Inventor: Svetozar GRBIC, München (IL)

(21) Appl. No.: 18/014,377

(22) PCT Filed: Jul. 7, 2021
(86) PCT No.: PCT/EP2021/068818

§ 371 Date: Jan. 4, 2023

(30) Foreign Application Priority Data
Jul. 7, 2020 (DE) 20 2020 103 929.6

(51) Int. Cl. A47C 7/42; A47C 7/46

(52) U.S. Cl. CPC A47C 7/425; A47C 7/462

(57) ABSTRACT

The present invention relates to a lumbar support for fastening to a backrest of a seat, comprising or consisting of a lumbar support body and a fastening strap fastened to at least two points on the lumbar support body, the fastening strap being of substantially inelastic form in a bracing direction, and the bracing length of the fastening strap being adjustable using at least one bracing means. The invention furthermore relates to the use of the lumbar support according to the invention with a backrest of a seat.

The present invention relates to a lumbar support for fastening to a backrest of a seat, comprising or consisting of a lumbar support body and a fastening strap fastened to at least two points on the lumbar support body, the fastening strap being of substantially inelastic form in a bracing direction, and the bracing length of the fastening strap being adjustable using at least one bracing means. The invention furthermore relates to the use of the lumbar support according to the invention with a backrest of a seat.

The lordosis is the natural curvature of the lumbar spine toward the abdomen. A lumbar support, also referred to as lordosis support, is an element on a backrest of a seat that supports the lumbar spine of a person sitting on the seat. If the muscles of the lumbar spine become fatigued when sitting for long periods of time, a lumbar support assists in maintaining the natural posture with lordosis, without the curvature of the lumbar spine changing to a rearwardly directed curvature.

Lumbar supports are commonly used in sectors in which people remain seated for long periods of time, as may be the case for example when sitting in automobiles or in offices. Many office chairs or automobile seats therefore already have integrated lumbar supports that ensure a healthy sitting position of the seated persons.

Aside from the abovementioned integrated lumbar support, embodiments are also known in which the lumbar support is of independent form and can be attached to different seats. Seats which do not have an integrated lumbar support can therefore also be expanded to include a lumbar support. It is common for an appropriately shaped element to be attached as a lumbar support to the backrest of a seat. Such an element may for example be a pad or a frame over which a support lining has been tensioned.

DE 20 2015 008 090 U1 has described a lumbar support for use in conjunction with a seat arrangement, in particular a chair, seat, armchair or sofa, with a bracing frame and with a support means that is held on the bracing frame and with at least one bracing means that acts on the bracing frame, the bracing means having an adjustment device for adjusting the prestress of the bracing frame. To connect the lumbar support to the seat, a connecting means that has an elastic band is described.

The applicant’s own tests have however shown that the lumbar support described in the prior art has the disadvantage that it can slip on the seat if the user moves. A reason for this is the fact that the support is held only by an elastic band, the holding action of which is limited by the elasticity of the band. It has furthermore been found that the bracing force of the elastic band decreases over time owing to the aging of the elastic material, resulting in (additional) loosening of the lumbar support on the seat.

Against this background, it is an object of the present invention to provide a lumbar support that can be securely located on a backrest, allows this secure locating action to be maintained over a long period of time, and allows the lumbar support to be retrofitted on seats easily and quickly.

Said object is achieved by means of a lumbar support for fastening to a backrest of a seat, comprising or consisting of a lumbar support body and a fastening strap fastened to at least two points on the lumbar support body, the fastening strap being of substantially inelastic form in a bracing direction, and the bracing length of the fastening strap being adjustable using at least one bracing means.

The applicant’s own tests have surprisingly shown that lumbar supports can be attached very quickly and conveniently to a backrest of a seat through the use of inelastic fastening straps with a facility for increasing the bracing length of the strap using a bracing means. Since the fastening straps are inelastic, it is possible for the lumbar supports to be lashed to the seat, and slippage of the lumbar supports can hereby be avoided. By contrast to the situation when using elastic fastening straps, slippage of the lumbar supports can be avoided. Since the use of elastomers can be dispensed with in the case of inelastic straps, it has furthermore been found that the fastening to the backrest remains secure even over a very long period of time. The applicant’s own tests have furthermore shown that elastic materials tend to lose their bracing force, or become brittle, over time. This effect is intensified in particular if the materials are exposed to high temperatures and/or direct irradiation with light, for example in an automobile during summer months.

In the context of the present invention, elasticity of a strap is to be understood to mean the property whereby the belt can change its length under the action of force, and returns to the original form or the original length when the force is withdrawn. Elastic straps are known to a person skilled in the art for example in the form of rubber bands or rubber straps. These are distinct from fastening straps of inelastic form. Inelastic bands do not undergo any change in length, or undergo only an insignificant change in length, under the action of force during use, and do not return into the original form or to the original length when the force is withdrawn. Inelastic straps are known to a person skilled in the art for example in the form of tension bands or lashing straps. In the context of the present text, a strap is inelastic if the increase in length of the strap under the action of a force of 30 daN is less than 10%. For the measurement of the increase in length, a band of 100 mm length is initially subjected to a force of 30 daN in the bracing direction of the strap. The acting force is subsequently withdrawn, and the length of the relaxed strap is measured. A force of 30 daN is subsequently exerted along the bracing direction of the strap, and the subsequent length of the strap under the action of force is measured. The quotient of length under the action of force and length prior to the action of force in % yields the increase in length in %.

According to the invention, a lumbar support is preferred in the case of which the bracing means is selected from the group comprising cam buckles, clamping buckles, flap buckles, slider buckles, ladder-type buckles (preferably) with a grip tab, strapping buckles and clip buckles with single or twofold adjustment capability. Clamping buckles and clip buckles with single or twofold adjustment capability are particularly preferred here. These bracing means are known to a person skilled in the art and are commonly used for example on textile items of luggage, such as rucksacks, or on articles of clothing. DE102017116825A1 describes, for example, clip buckles (referred to in said document as plug-type fasteners; reference designation 13) and clamping buckles (reference designation 18). Ladder-type buckles constitute a preferred form of clamping buckles. The applicant’s own tests have shown that the use of these bracing means allows particularly straightforward and quick fastening of the lumbar support. If a clip buckle with single or twofold adjustment capability is used, it is furthermore possible to install lumbar supports which cannot, or can only with great difficulty, be slipped over the backrest of a seat. Some tests have shown that ladder-type buckles (preferably with a grip tab) are particularly preferred.

According to the invention, the bracing means is preferably formed from a plastics material, preferably from polypropylene, polyethylene, polyamide or polyester, wherein the plastics material may also be fiber-reinforced (for example glass-fiber-reinforced). According to the invention, it is particularly preferred if the bracing means is formed from polypropylene. The applicant’s own tests have shown that polypropylene is particularly durable under tension for particularly long periods of time owing to its specific density and hardness, and the lumbar support hereby remains securely lashed for particularly long periods of time. Alternatively, but less preferably, the bracing means may also be formed from a metal.

According to the invention, a lumbar support is preferred in the case of which the fastening strap consists of polypropylene, polyethylene (in particular UHMWPE), polyamide, polyester and/or cotton or comprises at least one of these substances. According to the invention, it is preferable if the fastening strap comprises no elastomers.

According to the invention, a lumbar support is preferred in the case of which an increase in length of the fastening strap under the action of a force of 30 daN is less than 10%, preferably less than 5%, particularly preferably less than 2.5%.

In the context of the present invention, an elastomer is to be understood to mean a polymer involving dimensionally rigid but elastically deformable plastics materials, the glass transition point of which lies below the operating temperature. For lumbar supports, the operating temperature is normally approximately 20° C., though may also be lower or higher in specific applications.

According to the invention, a lumbar support is preferred in the case of which the lumbar support body consists of or comprises
a bracing frame,
a covering fastened to the bracing frame, and
at least one bracing device that acts on the bracing frame.

The design of the lumbar support according to the invention with a bracing frame, covering and bracing device may be analogous to that of the lordosis support described in DE 20 2015 008 090 U1. In this context, with regard to possible embodiments of the bracing device, reference is made in particular to paragraphs [0010] to [0018] of DE 20 2015 008 090 U1, and with regard to possible embodiments of the covering, reference is made to paragraphs [0019] to [0028] of DE 20 2015 008 090 U1.

Both the shape and the support force of the lumbar support body are easily adjustable by means of the bracing device. The lordosis support can thus be adapted to the body shape and/or the weight of different users. Shortening the bracing device increases the bracing force in the bracing frame, such that the covering is more strongly braced. When a force acts, for example when a user leans on the lumbar support, this force is opposed by a higher resistance owing to the higher bracing action of the lumbar support body.

It is preferable for the bracing device to be configured as at least one, in particular split, piece of webbing with a first webbing portion and a second webbing portion, or to have such a piece of webbing. A piece of webbing of the type mentioned above, for example in the form of a bracing strap, is particularly highly suitable for accommodating high forces, and is furthermore robust with respect to mechanical damage. The design with a first webbing portion and a second webbing portion allows a length adjustment of the piece of webbing or of the bracing means, whereby the preload of the bracing frame is adjustable, and the lordosis support itself is adaptable to forces acting thereon.

According to the invention, a lumbar support is preferred in the case of which the bracing frame comprises a main element composed of plastics material, preferably a thermoset, or metal, preferably spring steel.

According to the invention, a lumbar support is preferred in the case of which the main element is a wire.

According to the invention, a lumbar support is preferred in the case of which the main element is encased with a textile.

According to the invention, a lumbar support is preferred in the case of which support means have an in particular textile, preferably mesh-like fabric. According to the invention, the fabric is preferably a fabric that comprises or consists of polypropylene fibers.

According to the invention, a lumbar support is preferred in the case of which the support means has a massage unit which is preferably composed of polypropylene and which preferably comprises nubs that impart a massage effect.

According to the invention, a lumbar support is preferred in the case of which the support means are designed to be permeable to air and/or vapor.

According to the invention, a lumbar support is preferred in the case of which the bracing device is of substantially inelastic form in a bracing direction, and the bracing length of the bracing device is adjustable using at least one bracing means.

According to the invention, a lumbar support is preferred in the case of which the bracing device is a piece of webbing.

In an alternative embodiment, the lumbar support body may be a foam material body, a latex body, a plastics material body, a back or lumbar cushion, an air-filled body, or hybrid forms of these bodies.

A further aspect of the present invention relates to the use of the lumbar support according to the invention with a backrest of a seat, the seat preferably being selected from the group comprising: chair, office chair, kitchen chair, folding chair, armchair, automobile seat, truck seat, tractor seat, construction vehicle seat, aircraft seat, ship or boat seat, vehicle seat, hunting seat and fishing seat.

1. A lumbar support for fastening to a backrest of a seat, comprising or consisting of a lumbar support body and a fastening strap fastened to at least two points on the lumbar support body,
wherein the fastening strap is of substantially inelastic form in a bracing direction, the bracing length of the fastening strap being adjustable using at least one bracing means.

2. The lumbar support as claimed in claim 1, the bracing means being selected from the group comprising cam buckles, clamping buckles, flap buckles, slider buckles, ladder-type buckles (preferably with a grip tab), strapping buckles and clip buckles with single or twofold adjustment capability, particularly preferably selected from the group comprising clamping buckles and clip buckles with single or twofold adjustment capability.

3. The lumbar support as claimed in any one of the preceding claims, the fastening strap consisting of polypropylene, polyethylene (in particular UHMWPE), polyamide, polyester and/or cotton or comprising at least one of these substances.

4. The lumbar support as claimed in claim 1, the lumbar support body consisting of or comprising
- a bracing frame,
- a covering fastened to the bracing frame, and
- at least one bracing device that acts on the bracing frame.

5. The lumbar support as claimed in any one of the preceding claims 2 to 4, the bracing frame comprising a main element composed of plastics material, preferably a thermoset, or metal, preferably spring steel.

6. The lumbar support as claimed in claim 5, the main element being a wire.

7. The lumbar support as claimed in claim 5 or 6, the main element being encased with a textile.

8. The lumbar support as claimed in claims 2 to 7, support means having an in particular textile, preferably mesh-like fabric.

9. The lumbar support as claimed in claims 2 to 7, the support means being designed to be permeable to air and/or vapor.

10. The lumbar support as claimed in claims 2 to 7, the bracing device being of substantially inelastic form in a bracing direction, and the bracing length of the bracing device being adjustable using at least one bracing means.

11. The lumbar support as claimed in claims 2 to 7, the bracing device being a piece of webbing.

12. The use of the lumbar support as claimed in any one of claims 1 to 11 with a backrest of a seat, the seat preferably being selected from the group comprising: chair, office chair, kitchen chair, folding chair, armchair, automobile seat, truck seat, tractor seat, construction vehicle seat, aircraft seat, ship or boat seat, vehicle seat, hunting seat and fishing seat.
